(19) United States
(12) Patent Application Publication
(10) Pub. No.: US 2026/0266376 A1
(43) Pub. Date: Sep. 10, 2026

(54) SEALING SEGMENT FOR A TURBOMACHINE

(71) Applicant: Siemens Energy Global GmbH & Co. KG, Munich, Bayern (DE)

(72) Inventors: Arthur Alder, Oberhausen (DE); Thomas Brol, Essen, NRW (DE); Simon Hecker, Recklinghausen (DE); Sven Jerabeck, Mülheim (DE); Christian Musch, Mülheim an der Ruhr (DE); Tobias Rühle, Mülheim (DE); Norbert Thamm, Essen (DE); Michael Wechsung, Mülheim an der Ruhr (DE)

(73) Assignee: Siemens Energy Global GmbH & Co. KG, Munich, Bayern (DE)

(21) Appl. No.: 19/162,936

(22) PCT Filed: Aug. 16, 2023
(86) PCT No.: PCT/EP2023/072608

§ 371 Date: Sep. 7, 2025

(30) Foreign Application Priority Data
Mar. 13, 2023 (DE) 10 2023 202 257.5

(51) Int. Cl. F16J 15/40; F01D 11/04

(52) U.S. Cl. CPC F16J 15/40; F01D 11/04; F05D 2240/55

(57) ABSTRACT

A sealing segment for sealing a gap between a component which rotates about an axis of rotation and a stationary component, wherein a flow medium which flows between the sealing segment and the rotating component during operation has, with respect to the axis of rotation, an axial flow component and a tangential flow component, wherein the sealing segment has a lower side facing the rotating component, wherein the rotating component has a sealing tip, wherein the sealing tip faces the lower side, wherein the lower side has a region facing the sealing tip, wherein the region has recesses in a circumferential direction with respect to the axis of rotation.

### CROSS REFERENCE TO RELATED APPLICATIONS

This application is the US National Stage of International Application No. PCT/EP2023/072608 filed 16 Aug. 2023, and claims the benefit thereof, which is incorporated by reference herein in its entirety. The International Application claims the benefit of German Application No. DE 102023202257.5 filed 13 Mar. 2023.

### FIELD OF INVENTION

The invention relates to a seal segment for sealing a gap between a component rotating about a rotational axis and a stationary part, wherein a flow medium flowing during operation between the seal segment and the rotating component has an axial and tangential flow component with regard to the rotational axis, wherein the seal segment has a lower side which lies opposite the rotating component, wherein the rotating component has a sealing tip, wherein the sealing tip is configured so as to lie opposite the lower side.

### BACKGROUND OF INVENTION

Turbomachines within the context of this invention are, for example, steam turbines, gas turbines or compressors, wherein the invention preferably relates to steam turbines. Turbomachines are distinguished by a flow medium. The collective term “turbomachines” combines water turbines, steam and gas turbines, wind turbines, centrifugal pumps and centrifugal compressors, and propellers. A common feature of all these machines is that they serve the purpose of drawing energy from a fluid, in order to drive another machine with it, or, conversely, to supply energy to a fluid in order to increase its pressure. In turbomachines, the energy conversion is indirect and preferably takes the path via the kinetic energy of the fluid.

In turbomachines such as, for example, in the case of steam turbines, a flow medium flows during operation in a main flow direction which corresponds substantially to the direction of the rotational axis. The flow medium should ideally flow merely what is known as a flow duct which has what are known as guide vanes and rotor blades. The flow duct is usually formed from different guide vanes and rotor blades arranged behind one another. The flow medium flows through the flow duct past the guide vanes and rotor blades, wherein the kinetic energy is converted into rotational energy, which leads to a rotation of the rotor. Since a movement of the rotor takes place in a housing, there are gaps between the housing and the rotor, which gaps should be configured to be as small as possible. Nevertheless, gaps cannot be avoided, which leads to an undesired flow through the gaps. The undesired flow results from the main flow, wherein one part branches off from the main flow and flows through the gap. This gap flow can also be called a secondary flow, wherein it is an aim in every design of a turbomachine for the secondary flow to be kept as low as possible. Therefore, different approaches exist for minimizing the secondary flow. A first approach consists in what are known as sealing lips or sealing tips being arranged between the rotating components and the stationary components. The sealing lips or sealing tips are arranged in a rotationally symmetrical manner and act as it were as a barrier for the secondary flow. In this way, a secondary flow which flows substantially to the main flow is braked.

In turbomachine engineering, however, the secondary flow leads to a further effect which is undesired. The secondary flows through the gaps can bring about or damp rotor vibrations which are present during operation, which emerges depending on prevailing boundary conditions. This effect is called gap excitation in turbomachine engineering. This effect is called steam fanning specifically in steam turbine engineering. Since the flow medium proportion which branches off in the direction of the gap has different directional components, there are also directional components which are directed in the circumferential direction in addition to the main directional component which leads along the main flow duct. This secondary flow component which is directed in the circumferential direction is also called a swirl. The gap excitation or steam fanning is dependent on the direction and magnitude of this swirl of the secondary flow during entry into the gap. In general, the secondary flow has the effect in the case of turbines that a fanning effect tends rather to take place instead of a damping effect.

This fanning effect is disruptive, and there are efforts to prevent this disruption. It is known here for swirl interrupters in different designs to be used. Swirl interrupters are understood here to mean components which form a barrier for the secondary flow which flows in the circumferential direction and is called a swirl.

As an alternative to this or in addition, a brake fluid can be blown into the secondary flow in such a way that the swirl is minimized or prevented as a result.

The swirl interrupters are configured from individual components and are incorporated individually into the housing in the circumferential direction in a suitable way. This leads to high manufacturing complexity, which leads to an increased manufacturing time.

In a steam turbine as one embodiment of a turbo machine, steam is used as flow medium. The steam forms a mass flow and has thermal energy which is ultimately converted in the steam turbine into rotational energy. This rotational energy leads to a rotor which is mounted rotatably about a rotational axis rotating at any desired frequencies. The majority of the mass flow flows along what are known as guide vanes and rotor blades, wherein a certain portion flows as leakage mass flow between the stationary and the rotating components. This mass flow which flows between the rotating component and the stationary component is not utilized for work between the guide vanes and rotor blades, which results in a loss in the degree of efficiency. This leakage mass flow should be decreased.

A further problem of these leakage mass flows lies in the fact that the flow direction has both an axial direction which points in the rotational axis and a tangential direction which points in the circumferential direction. This leads to the leakage mass flow driving a rotation in the direction of the rotational movement, which rotation, as described above, is called a swirl. An excessive swirl is distinguished by the fact that the tangential speed of the leakage mass flow is comparatively high, as a result of which a vibration might be fanned, which can lead to unfavorable influencing of the rotordynamic stability.

It is therefore desirable for the swirl of the leakage mass flow to be decreased. To this end, the above-described swirl interrupters, which are configured as grooves which are milled in the housing, and flow guide plates, which deflect the flow direction of the leakage mass flow, are used. It is known, furthermore, for what are known as flow dam seals to be used which are also called axially running sealing tips, in order to change the flow direction. Obstacles in the flow path are likewise suitable means for decreasing the tangential flow component of the leakage mass flow. For example, brush seals can be an obstacle of this type.

The center point of a turbine shaft does not as a rule remains statically in a certain position, but rather performs an orbital movement about an imaginary center. Both circular and elliptical paths are possible here. Under these conditions, flow phenomena which generate forces on the shaft which move with the orbital movement occur in contact-free seals of turbines such as, for example, on cover bands of turbine stages or shaft seals which exist at the shaft ends or else in the center of the machine, in a manner which is dependent on, for example, the rotational speed, orbital frequency, circumferential speed of the fluid upstream of and within the seal and/or labyrinth seal design. It is thus possible that a pressure field which rotates about the rotating shaft can be developed and, in the unfavorable case, can lead to an undesired rotor excitation.

Therefore, the inlet swirl upstream of the seal should be kept as small as possible or even be developed counter to the rotor rotational direction when the fluid flow enters into the seal. As described above, swirl interrupters are utilized for this purpose which usually comprise a multiplicity of small fins and direct the flow as desired.

It would be desirable for the tangential component of the leakage mass flow to be decreased by way of simple means.

### SUMMARY OF INVENTION

This is where the invention comes into play, the object of which is to decrease the swirl of the leakage mass flow.

This object is achieved by a seal segment for sealing a gap between a component rotating about a rotational axis and a stationary part, wherein a flow medium flowing during operation between the seal segment and the rotating component has an axial and tangential flow component with regard to the rotational axis, wherein the seal segment has a lower side which lies opposite the rotating component, wherein the rotating component has a sealing tip, wherein the sealing tip is configured so as to lie opposite the lower side, wherein the lower side has a region which is arranged so as to lie opposite the sealing tip, wherein the region has recesses in a circumferential direction as viewed on the rotational axis.

In this way, a novel embodiment of a swirl interrupter is presented. The recesses produce an effective possibility for configuring a swirl interrupter.

Advantageous developments are specified in the subclaims.

In a first advantageous development, the recesses are arranged at equidistant spacings in the circumferential direction.

This leads to targeted flows and to the possibility of simpler production of the recesses.

In one advantageous development, a plurality of sealing tips are arranged on the lower side, wherein the sealing tips are arranged behind one another along the rotational axis.

In one advantageous development, the rotating component likewise has a plurality of sealing tips lying opposite the lower side, wherein the sealing tips are arranged behind one another along the rotational axis.

In one particularly advantageous development, the recesses are arranged so as to lie opposite on the last (as viewed in the flow direction along the rotational axis) sealing tip on the rotating component. In this way, the swirl interrupters are arranged so as to lie opposite the last sealing tip. This leads to a particularly effective decrease in the secondary flow.

In one advantageous development, the recesses have a circular (strictly speaking, semicircular) configuration as viewed in the rotational direction. This can be produced particularly simply. If the spacing between the rotating component and the lower side is L, the diameter D of the circular shape should lie between 3×L and 10×L.

In one advantageous refinement, the recesses are spaced apart in the circumferential direction in such a way that a web with a width d is produced between the recesses. Particularly advantageous flow conditions can be achieved if the web is configured such that the following applies: d=0 to d=5×D.

In a further advantageous development, the recesses are inclined by an angle β with respect to the rotational axis as viewed in the radial direction. Particularly advantageous flow conditions can be achieved if the recesses are configured such that the following applies: 0<|β|<20°.

In one advantageous development, the recess is configured in such a way that the tangent of the recess on the web is inclined by an angle α with respect to the radial direction. Particularly advantageous flow conditions can be achieved if the recesses are configured such that the following applies: 0<|α|<20°.

According to the invention, the swirl interrupter consists of recesses in the stationary part of the seal which are large axial recesses in relation to the size of a labyrinth seal chamber or are inclined by up to 20° about the axial or circumferential axis. The diameter is 3 to 10 times the spacing of the rotor from the housing. The number of recesses in the circumferential direction is to be dimensioned such that there are radial webs. The webs therefore have a width from 0 to 5 times the diameter of the axial recesses. The recess may also differ from the circular shape and may be polygonal, oval or rounded. The sealing tip which is arranged on the rotor side and has to be applied below the axial recesses hurls the fluid radially outwardly into the large chambers in the stator. The circumferential swirl dissipates in these chambers, since the fluid is hurled against the flanks of the axial recesses which do not allow any circumferential mass flow. In the further course, the fluid which then remains in the circumferential direction flows into the seal again and is dragged along by the rotor.

The seal segment according to the invention can be produced rapidly and inexpensively. The swirl interrupter according to the invention is efficient and can remove the swirl almost completely from the swirl flow. In addition, it can be used multiple times within one seal (since its dimensions are small), as a result of which the overall flow regime in the seal can be trimmed.

In the following text, one exemplary embodiment of the invention will be explained in greater detail on the basis of the following figures.

The above-described properties, features and advantages of this invention and the manner in which they are achieved will become clearer and easier to understand in conjunction with the following description of the exemplary embodiments which are explained in greater detail in conjunction with the drawings.

Identical components or components with an identical function are characterized by identical reference signs here.

### BRIEF DESCRIPTION OF THE DRAWINGS

Exemplary embodiments of the invention will be described in the following text on the basis of the drawings. The latter are not intended to illustrate the exemplary embodiments to scale, but rather the drawing is configured in a diagrammatic and/or slightly distorted form where this is useful for explanatory purposes. Reference is made to the relevant prior art with regard to additions of the teachings which can be seen directly in the drawing, in which:

FIG. 1 shows a perspective illustration of a seal segment,

FIG. 2 shows a plan view of a seal segment,

FIG. 3 shows a side view of a seal segment, and

FIG. 4 shows a side view of a seal segment in an alternative embodiment.

### DETAILED DESCRIPTION OF INVENTION

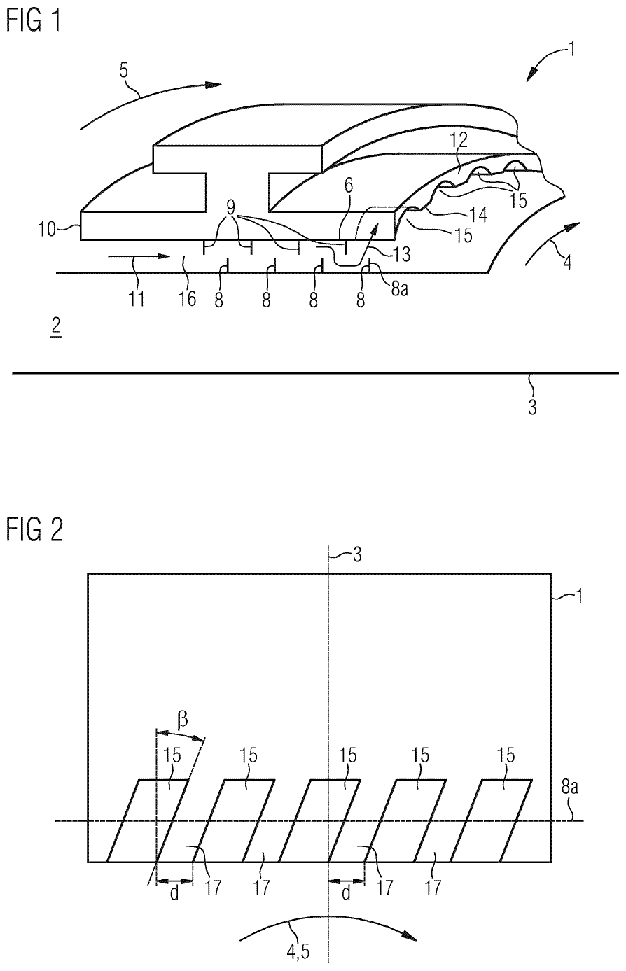

The seal segment 1 which is shown in FIG. 1 is used, for example, in a steam turbine as one embodiment of a turbomachine. A seal segment 1 of this type is arranged in the housing (not shown) in which a component 2 which rotates about a rotational axis 3 and can be configured as a rotor is arranged. The rotor which is shown in FIG. 1 rotates by way of example in the clockwise rotational direction 4 during operation. The seal segment 1 is configured in a circumferential direction 5. This means that the seal segment 1 substantially follows the circumferential direction 5, that is to say is of curved configuration. Grooves which are configured to receive sealing tips 8 are arranged on a lower side 6 which is arranged during operation opposite an upper side 7 of the rotating component 2.

The seal segment 1 is configured to seal a gap 16 between the rotating component 2 and a stationary component (not shown).

Grooves which are configured to receive sealing tips 9 are likewise arranged on the upper side 7 of the rotating component 2.

As shown in FIG. 1, a type of labyrinth seal arises as a result between the seal segment 1 and the rotating component 2. The seal segment 1 has an end side 10. During operation, a flow medium flows in the flow direction 11 between the seal segment 1 and the rotating component 2 on the upper side 7 through the labyrinth seal which is formed with sealing tips 8 and 9.

At the end-side end 12 of the seal segment 1, the flow has a swirl 13 in the circumferential direction 5. Swirl interrupters 14 in the form of recesses 15 are arranged so as to lie opposite a last (as viewed in the flow direction 11) sealing tip 8a. The swirl interrupters 14 result from the removal of material of the lower side 6 of the seal segment 1, as a result of which the recesses 15 arise.

Here, the swirl interrupters 14 are intended to counteract the swirl 13 in the flow and therefore represent a barrier which counteracts a flow in the circumferential direction 5.

FIGS. 2, 3 and 4 show embodiments of the swirl interrupters 14 or recesses 15 and will be described in the following text.

FIG. 2 shows a diagrammatic plan view of the end of the seal segment 1. The recesses 15 are arranged at a distance spacings in the circumferential direction 5. This means that a web 17 is configured between two recesses 15. The web 17 counteracts, as an elevation, the flow (not shown in FIG. 2) and therefore prevents a flow in the circumferential direction 5. The recesses 15 are therefore milled into the seal segment 1 in a material-removing manner at an angle β by way of suitable milling measures. Here, the magnitude of the angle β has values between 0 and 20°. Milling is carried out substantially close to the surface, with the result that an indentation arises. The webs 17 which have a width d arise as a result of the milling measure. If the recess 15 is a circle or circular segment with a diameter D, the width d of the webs is defined by the following equation: d=0 to 5×D. For reasons of clarity, merely two webs 17 are provided with the reference sign d in FIG. 2. As FIG. 2 clearly shows, the recesses 15 are arranged above the sealing tip 8a which is attached in a rotating component 2.

Therefore, the means for decreasing the tangential flow component are realized as milled recesses.

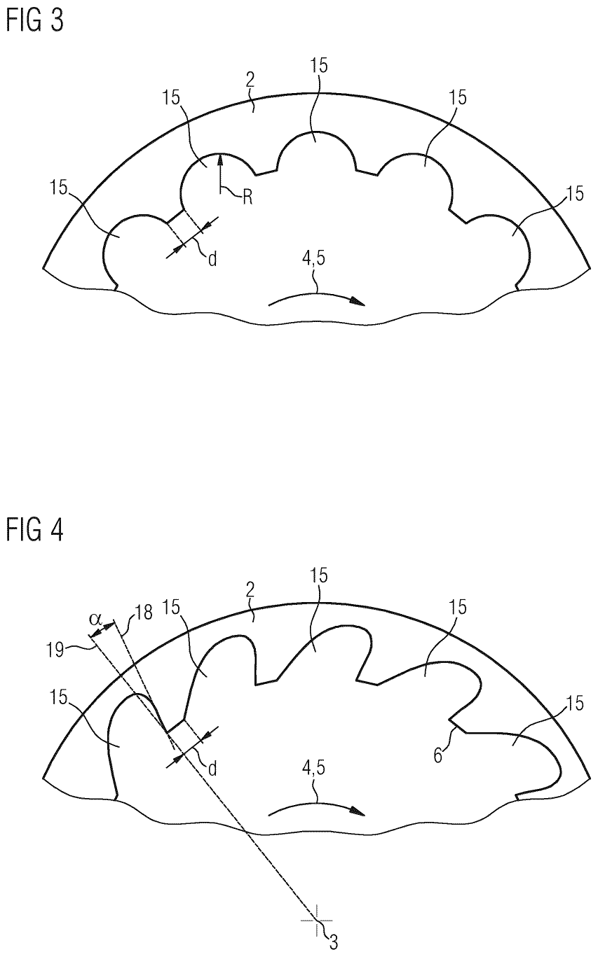

FIG. 3 shows a side view of the seal segment 1. The shape of the recesses 15 corresponds to a circle or a circular segment with a diameter D. The following applies: D=2*R. The spacing between the rotating component 2 and the lower side is L (not shown in FIG. 3). The following applies to the spacing than the diameter D: D=(3 . . . 10)×L. In other words: the diameter D of the recess 15 is 3 to 10 times the spacing L of the rotor 2 from the sealing segment 1. The number in the circumferential direction 5 is dimensioned in such a way that radial webs 17 arise. The webs 17 therefore have a width d from zero to five times the diameter D of the axial recesses 15. The recess 15 may also differ from the circular shape and be polygonal, oval or rounded, which is then described in greater detail in FIG. 4. The recesses 15 in FIG. 4 differ from the circular shape and are rounded to such that a tangent 18 can be placed at the location of the transition to the web 17. The tangent 18 and the radial direction 19 are arranged at an angle α with respect to one another. The following applies to the magnitude of the angle α: 0<α<20°. For reasons of clarity, merely one web 17 is provided with the reference sign d in FIG. 4, and the angle α is shown only for one recess 15.

Although the invention has been illustrated and described in greater detail by the preferred exemplary embodiment, the invention is not restricted to the disclosed examples, and other variants can be derived herefrom by a person skilled in the art, without departing from the scope of protection of the invention.

1. A seal segment for sealing a gap between a component rotating about a rotational axis and a stationary part, wherein a flow medium flowing during operation between the seal segment and the rotating component has an axial and tangential flow component with regard to the rotational axis, wherein the seal segment comprises:
a lower side which lies opposite the rotating component,
wherein the rotating component comprises a sealing tip (8, 8a), wherein the sealing tip (8, 8a) is configured so as to lie opposite the lower side,
wherein the lower side comprises a region which is arranged so as to lie opposite the sealing tip (8, 8a),
wherein the region comprises recesses in a circumferential direction as viewed on the rotational axis.

2. The seal segment as claimed in claim 1,
wherein the recesses are arranged at equidistant spacings in the circumferential direction.

3. The seal segment as claimed in claim 1,
wherein the seal segment comprises a plurality of sealing tips (9) on the lower side.

4. The seal segment as claimed in claim 1,
wherein the sealing tips (8, 8a, 9) are arranged behind one another along the rotational axis.

5. The seal segment as claimed in claim 1,
wherein the rotating component comprises a plurality of sealing tips (8, 8a) lying opposite the lower side, wherein the sealing tips (8, 8a) are arranged behind one another along the rotational axis.

6. The seal segment as claimed in claim 1, comprising:
a last sealing tip (8a) on the rotating component, when viewed in the flow direction along the rotational axis, wherein the recesses are arranged so as to lie opposite the last sealing tip (8a).

7. The seal segment as claimed in claim 1,
wherein the recesses have a substantially circular shape as viewed in the direction of the rotational axis.

8. The seal segment as claimed in claim 7,
wherein the circular shape has a diameter D, wherein a spacing between the rotating component and the lower side is L, wherein the following applies: D=(3 . . . 10)×L.

9. The seal segment as claimed in claim 7,
wherein the recesses are spaced apart in the circumferential direction in such a way that a web with a width d is produced between the recesses.

10. The seal segment as claimed in claim 9,
wherein the following applies to the width d: d=0 to 5×D.

11. The seal segment as claimed in claim 1,
wherein the recesses are inclined by an angle β with respect to the rotational axis as viewed in a radial direction.

12. The seal segment as claimed in claim 11,
wherein the following applies to the angle β: 0<|β|<20°.

13. The seal segment as claimed in claim 9,
wherein the recesses are configured in such a way that the tangent of the recess on the web is inclined by an angle α with respect to a radial direction.

14. The seal segment as claimed in claim 13,
wherein the following applies to the angle α: 0<|α|<20°.
